(19) United States
(12) Patent Application Publication
(10) Pub. No.: US 2004/0039627 A1
(43) Pub. Date: Feb. 26, 2004

(54) Template driven creation of promotional planning jobs

(76) Inventors: Grant C. Palms, Richfield, MN (US); Justin Peck, Spooner, WI (US); Nicholas M. Schwendeman, Hastings, MN (US); Jason Johannes, New Hope, MN (US); Terry Beranak, Chanhassen, MN (US)

Correspondence Address: Beck & Tysver, P.L.L.C., Suite 100, 2900 Thomas Avenue S., Minneapolis, MN, 55416, US

(21) Appl. No.: 10/425,922

(22) Filed: Apr. 29, 2003

Related U.S. Application Data
(60) Provisional application No. 60/377,131, filed on Apr. 30, 2002.

(51) Int. Cl. G06F 17/60; G06F 7/00

(52) U.S. Cl. 705/9; 707/104.1

(57) ABSTRACT

A method and system are presented for creating promotion planning jobs that can be implemented in a workflow management system. Templates set forth specific tasks that will be implemented to perform the job. Tasks are assigned to a predefined role. Users of the system are assigned to roles, and then grouped together into teams. Each team is associated with a particular class. A team of users generally contains one user for each role needed to complete a job. A job is created from the template and assigned a class. A team is then selected based on this class. Users that make up that team are then assigned to the particular task based upon the users' role and the role assigned to the task by the template. If-a job is assigned to multiple classes, multiple teams will be assigned to the job. A master template allows multiple promotions to be coordinated. Jobs created from master templates have preliminary tasks that are generally performed before the tasks associated with jobs created from related sub-templates.

### CROSS-REFERENCE TO A RELATED APPLICATION

This application claims the benefit of U.S. Provisional Application No. 60/377,131, filed Apr. 30, 2002.

### TECHNICAL FIELD

The present invention relates generally to an automated workflow management system. More particularly, the present invention discloses a technique for using templates to define a promotional planning job that contains one or more tasks.

### BACKGROUND OF THE INVENTION

Retail chains use a number of strategies to promote products to their customers. These promotions can take many forms, such as print advertisements, radio and television advertisements, in-store product displays, promotional financing offers, and product bundling offers. With each promotion, many steps are required to ensure that the promotion is successful. Product must be purchased and delivered to the stores in sufficient quantities before the promotion begins. The promotion must be communicated to the buying public. In-store signage must be created to reflect the promotion. Because separate persons will generally control each of these steps, the planning, coordination, and execution of these promotions can become very involved.

Things become more difficult when multiple types of promotions are coordinated together for the same products. This type of coordinated promotion might require that the same product be promoted simultaneously in mailings to selected customers, weekly advertisement circulars, in-store promotional locations, and in radio and television advertisements. When the same product is promoted in bricks & mortar stores and on a retail web site, it is frequently even necessary to plan and coordinate the promotion across different organizational structures within a retail enterprise. The simple step of coordinating the timing of these multiple promotions can be difficult. For instance, in-store promotional spaces are typically only changed every 6 to 8 weeks due to labor costs, but a printed advertisement will highlight different products each week. Because advertisement does drive sales, the retailer planning an in-store promotional display for 6 weeks might want to highlight the item in a printed advertisement at least twice, such as during week one and four of the promotional display. The complexity of planning and coordinating promotions is even greater when many products are promoted together in a promotional event, such as a back-to-school event that might include coordinated promotions on clothing, computers, and school supplies.

Each promotion requires many people to complete tasks in a timely manner. An advertisement can't be created until the products have been selected, and in-store signs can't be printed until it's known what type of fixture will be used to sell the product and how many stores this product will be sold in. Some tasks cross multiple promotions, like choosing the products to promote, and others are specific to an individual promotion such as updating the website.

In a typical process, the first step is for a manager to determine the promotion's type and duration. For instance, a promotion could be a three-week holiday event, or a simple weekly ad. Once that has been determined, products need to be selected, inventory needs to be acquired, signs and ads need to be printed, and other promotions such as free financing or product bundling need to be set up. Though there are similarities, each promotion is different.

As an example, the planning of in-store promotional spaces will usually follow the same basic structure, but will differ from one promotion to another. Generally, retailers will prefer to create a single plan for all similar promotional locations in each of their retail stores. To accomplish this goal, the retailer assigns an identifier to those locations that appear in each of their stores, such as “checkout lane 1.” Locations at the end of the aisles are typically referred to as “end caps,” which can be grouped together for identification purposes by areas within the retail store. Thus, a grocery store chain might have a promotional location known as “breakfast cereal end cap 1,” a discount store might have a “sporting goods end cap 3,” and an electronics retailer might have a “television end cap 2. Not every store in a retail chain will have every location. For instance, a larger store might have five pharmacy end caps (pharmacy end caps 1-5), while a smaller store would have only three (pharmacy end caps 1-3).

Once the locations in the retail chain are identified, plans can be created for each of the promotional locations in the chain. The plan identifies the item or items to be displayed at the promotional locations, the signage to be used, and how product distribution should be altered to reflect the additional sales expected from the promotional location. To complete this plan, a supervisor would first approve a budget for this promotional location. The buyer for the department would then be responsible for ensuring that proper inventory is sent to the stores. A planogram analyst will create the display plan (or “planogram”) for the location. Finally, the department's advertising planner must design and create signage for the location.

Each of these individuals must work together to plan and implement this end cap display. It would be a relatively simply matter to implement this business process in standard workflow management computer software, such as iFlow by Fujitsu Software Corporation (San Jose, Calif.) or Lotus Workflow by IBM (Armonk, N.Y.). That is, it would be relatively simple as long as the process required to implement this plan is consistent for all promotional locations plans in the store. Unfortunately, the process of planning and implementing these plans in a large retail chain is rarely consistent. A different person in the organization might handle each step of the plan. Different promotional locations might fall under the purview of different departments in the retail chain. These different departments may use different individuals to manage each of the steps in promotional space planning. In addition, each department may desire an entirely different process by which their promotional spaces are managed. Finally, a retail chain may wish to have some promotional spaces move between different departments within the chain.

Unfortunately, traditional workflow management software programs are not capable of supporting the many variables that are present when multiple departments in a retail chain are responsible for planning promotions, especially when promotional space planning is combined with print advertising and e-commerce web site promotions. What is needed is a way to design workflow management jobs for promotion management that reflects the similarities between jobs, while allowing the flexibility to define each job separately.

### SUMMARY OF THE INVENTION

The present invention meets this need by providing a system and method that allows promotions management in a flexible, easy to implement manner. This is accomplished by basing the system on a job, defined as a plan for a specific promotion for a specific time period. Each job is based upon a template, which defines an ordered grouping of tasks that are to be preformed while planning a promotion. The specific tasks can vary between each of the templates, allowing jobs to vary according to department, specific promotional location, promotion type, or special event. The template may also specify the duration of the promotion. Multiple jobs can run simultaneously. This allows the planning of a master promotional job with various sub-promotions, allowing the coordination of multiple promotions as part of a single promotional event.

The individual tasks in a template are associated with one or more screens that are used to implement the business logic necessary to complete the task. Each of the screens contains the programming or other logic necessary to define this business logic. Each screen is also associated with a security field that helps control access to the screens on a user-by-user basis.

Templates associate individual tasks with the role that will perform that task. Individuals in the organization are assigned to roles as well as to teams. A team is a grouping of individuals that generally will work together on a particular project. For instance, each department would likely have at least one team. In fact, a department is likely to have a plurality of teams, with each team specializing on certain product categories within a department. Each team contains all of the roles necessary to complete a job, and assigns a particular user to each role. A user may serve on more than one team, and may perform more than one role.

When a job is created, a template is selected to fill out basic information about the job, including the duration of the job and the tasks to be performed. The promotions location and the implementation date for that promotion are also selected. The department that will manage the planning for this job is also selected, after which a team can be selected from among the teams that work in or with that department.

After the job is created, the present invention will handle the management of the job until it is completed. This includes notifying users that a task must be completed, and presenting to users the screens of data and procedures that are needed to complete the task. In this respect, the present invention is like prior art workflow management systems that implement tasks that are assigned to various users throughout an enterprise.

### BRIEF DESCRIPTION OF THE DRAWINGS

FIG. 1 is a box diagram showing the basic components of the present invention including the relationships and data flow between the various components.

FIG. 2 is the box diagram of FIG. 1, showing the screen and task components in more detail.

FIG. 3 is the box diagram of FIG. 1, showing the role, user, and team components in more detail.

FIG. 4 is the box diagram of FIG. 1, showing the details of the template component in more detail.

FIG. 5 is the box diagram of FIG. 1, showing the job component in more detail.

FIG. 6 is a box diagram showing the content of a sample job component.

FIG. 7 is a flow chart showing the method of the present invention.

FIG. 8 is a box diagram of a master template.

### DETAILED DESCRIPTION OF THE INVENTION

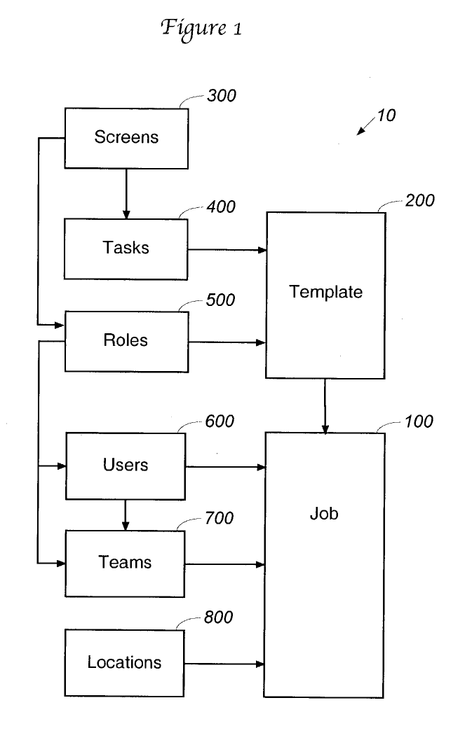

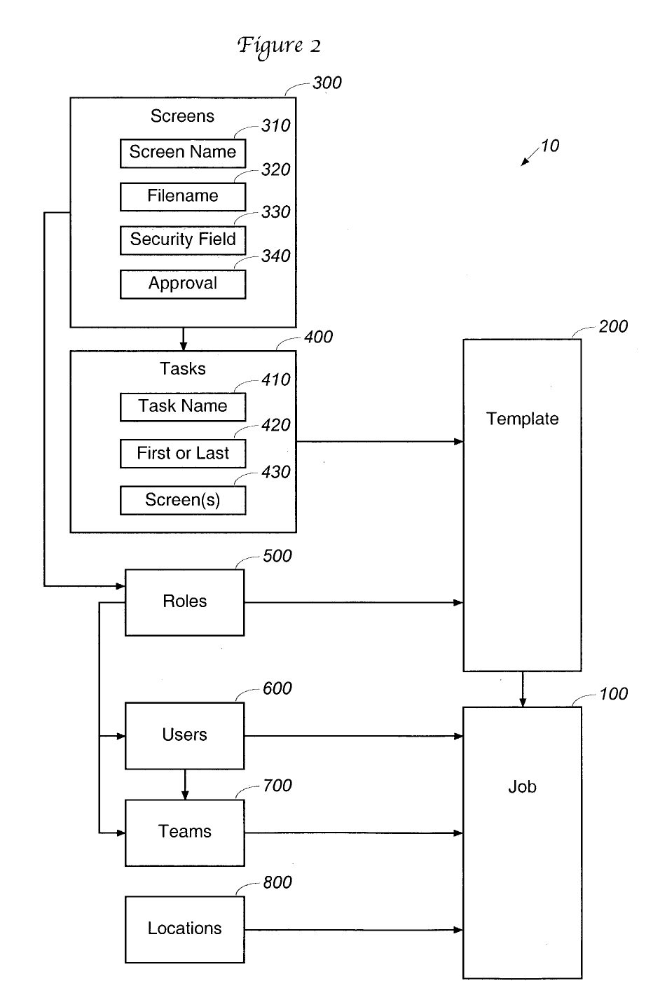

The present invention provides a flexible, automated system 10 for the planning of promotions in a retail chain, as shown in FIG. 1. In this system 10, separate jobs 100 are created for an identifiable promotional location during a particular time period. These jobs 100 are created using templates 200 and data from other components 300-800. These components include screens 300, tasks 400, roles 500, users 600, teams 700, and locations 800. Each of these components contains certain information that is used to define a job 100. The major connections and data relationships between these components 300-800, templates 200, and jobs 100 are shown by the arrows in FIG. 1, and are described in more detail in connection with FIGS. 2 through 5.

FIG. 2 shows the details of the screens 300 used by the present invention system 10. The screens 300 contain the actual business logic, data access, and user interface that allow the users 600 of the system 10 to plan and implement the promotions. For instance, it may be necessary for an inventory analyst to have access to current inventories and orders for a particular product before approving a particular strategy. If so, the programming necessary to obtain and present that information to the inventory analyst will be created and stored as part of a particular screen 300.

Ideally, the system 10 will be implemented so that all user interaction takes place through a traditional browser interface. In this type of environment, all interaction with data and business logic will take place through one or more screens 300 presented through the browser. Multiple pages of information that are linked together by a common user task or other logical connection can be presented to a user as a single screen 300 having separate tabs, with each tab presenting a single page of information to the user.

FIG. 2 shows detailed information that is maintained for each screen 300, specifically a screen name 310, a filename 320, a security field 330, and an approval indicator 340. The screen name 310 is simply the name that will be used by the system 10 to identify the particular screen 300. The filename 320 indicates the stored location of the programming that implements the business logic and user interface that makes up the screen 300. For instance, one screen 300 may utilize middleware components to access data in a corporate database, and then analyze that data using custom, C++ or Visual Basic programming. The analyzed data is then presented to the user 600 through a browser interface using HTML, DHTML, or XML formatting and associated style sheets. A user accesses these programming and related interface elements merely by opening the file location identified by filename 320 in the browser interface. In this way, the system 10 can be implemented on one or more servers interacting with one or more client browsers over a network, as is well known in the prior art.

The security field 330 is used to help determine the security access that a particular user will have for a screen. For instance, the preferred embodiment uses the following levels six levels of security:

No access to the screen;

Read only access;

Read and update access;

Full update access;

Full update and approval of non-overdue tasks access; and

Full update and override access for overdue tasks.

The level of access is set on a screen-by-screen basis. Each predefined role 500 will include default security settings for all of the available screens 300. When a user 600 is created that fills a particular role 500, the security settings for the role 500 will be used to create the security settings for the new user 600, as is described in more detail below.

In the preferred embodiment of the present invention, the security settings for all available screens 300 are set in a security string associated with a role 500 or user 600. These security strings each comprise a multi-digit number, with each digit representing the security setting for a different screen 300. The security field 330 shown in FIG. 2 is used to indicate which digit in the security field is used to define the security for this particular screen 300.

The approval field 340 is used to indicate whether a screen 300 is used as part of the workflow for a job 100, or whether the screen 300 is used only to administer the system 10. If the screen 300 forms part of the workflow for a job 100, then the screen 300 will end its processing with the user 600 either submitting information to the system 10, confirming that a task 400 was complete, or approving tasks 400 already completed by others. In contrast, administration screens 300 are accessed outside of the workflow of a particular job 100, and are used to monitor and update the system 10.

The system 10 uses the screens 300 to define the functions that are to be performed by the tasks 400. Much like prior art workflow processing systems, the tasks 400 in the present system 10 comprise a unit of work that is to be accomplished by an individual. As shown in FIG. 2, each task 400 is identified to the rest of the system 10 by a task name 410. Each task 400 also has a first or last task indicator 420, which is used to indicate whether a particular task 400 is allowed to be the first and/or last task 400 in a job 100. In some circumstances, a task 400 will be defined that requires that other tasks 400 occur before that task 400. This task 400 would not be allowed to be the first task 400 in a job 100. Other tasks 400 could be defined that require that additional tasks 400 follow after it, and hence would not be allowed to function as the last task 400 in a job 100. These situations would be reflected in the first or last task indicator 420 for these tasks 400. During the creation of a new job 100, the indicator field 420 for the first and last tasks 400 in the job 100 will be checked to confirm that these tasks 400 are allowed to start or end a job 100. If they were not, the job 100 would not be allowed by the system 10.

The screens field 430 indicates which screens 300 will be invoked to perform the task 400. In the preferred embodiment, each task 400 is assigned to only a single screen 300, with multiple pages of data being assigned to multiple tabs on that single screen 300. However, system 10 would be equally effective if a single task 400 were allowed to contain multiple screens 300 in screens field 430. In this type of environment, it would be necessary to define how the different screens 300 interrelate when a task 400 is performed.

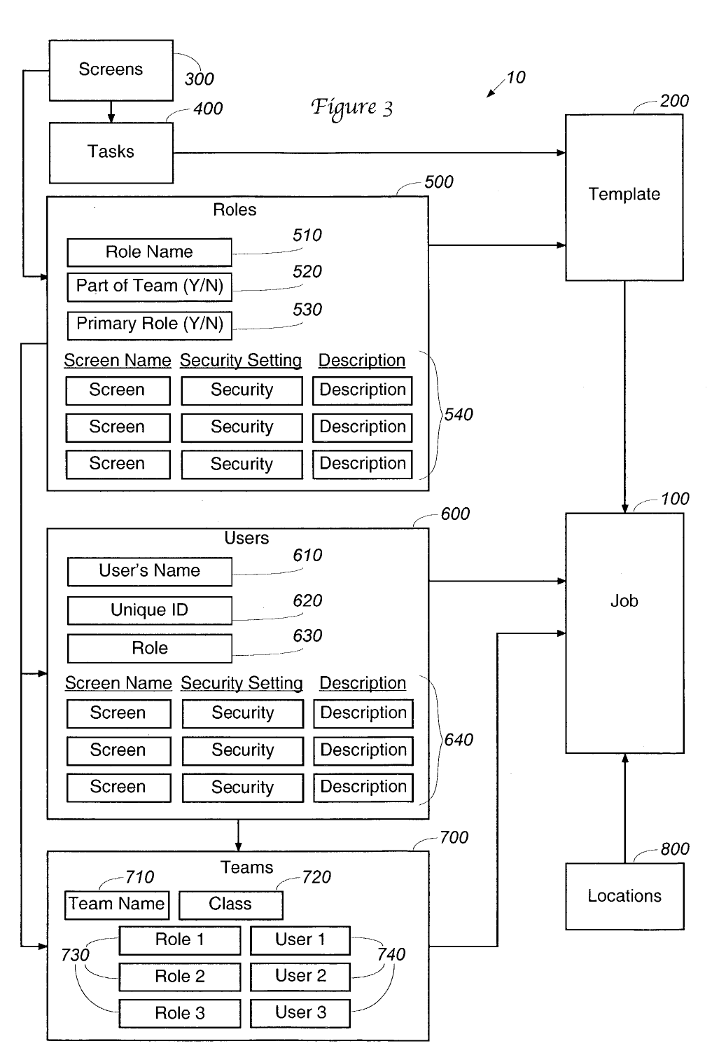

FIG. 3 shows the details of the roles 500, users 600, and teams 700 that are used in system 10. Much like prior art workflow management systems, roles 500 are used in the present invention to define the different business positions or roles that can be filled by individuals in a particular work environment. Example business positions that could be used by system 10 include a buyer, a system administrator, and an inventory analyst. Each role 500 is identified to the rest of the system 10 by a role name 510. Additional fields are used to define whether a particular role 500 can participate as part of a team 700 (field 520) and, if so, whether the role 500 is the primary role for the team 700 (field 530). These concepts are explained in more detail below.

Each role 500 contains security settings for each of the screens 300 of the present system 10. As explained above, these settings are stored in a security string, with each digit in the string representing the role's security setting for a different screen 300. To simplify the review and alteration of these settings, the present invention uses a table 540 to present this information to administrators of the system 10. The table 540 associates each screen name 310 with a numerical security setting (such as 1-6) and a description of the rights that are made available at the current security setting. An administrator would be able to change a role's security settings for a particular screen 300 merely by changing the screen's security setting in table 540.

Users 600 are the actual individuals who will perform the tasks 400 under the control of system 10. Each user 600 is identified by a user name 610, and can also be identified by a separate unique identifier 620, such as a UNIX login ID. Each user 600 is assigned to at least one role 500, which is tracked in role field 630. It is quite possible that a user 600 would be assigned to multiple roles. For instance, a buyer in a retailer's sporting goods department may also function as an administrator for the system 10. This individual would then be assigned to both the buyer role and the administrator role, with both roles being listed in field 630.

In addition, each user 600 is individually assigned security rights to the separate screens 300 used by the system 10. This is accomplished through the use of the security string previously described. When a user 600 is first assigned to a role 500, the security string associated with that role 500 is given to the user 600. Much like table 540, table 640 displays the security settings for a user 600 and allows the settings to be changed to give the user 600 more or fewer security rights than that normally assigned for their role 500.

Users 600 are grouped together into one or more teams 700 according to their role 500. Teams 700 are used in the present invention to identify users 600 that usually work together to plan a promotion. Generally, a retailer will group users 600 together by their department, division, product type, or other classification. In this way, a team 700 of users 600 that plan promotions for automotive products can be defined and exist separately from a team 700 that would plan promotions for sporting goods. When a job 100 is created, it is assigned to a team 700 that will implement that job 100.

Each team 700 is given a unique team name 710 so that the team 700 can be identified to the rest of the system 10. In one embodiment, the team name 710 is the user's name 610 of the user 600 that fills the primary role 530 for that team 700. Teams 700 are assigned to a particular class 720, which is based on a classification system that reflects the business of the particular retailer using the system 10. For instance, a retailer might use a classification system that divides the store into classes of goods, such as automotive products, sporting goods, health & beauty, small appliances, etc. Other possible classification schemes could be based on predefined department or divisions, on the geographic location of the store, or on physical locations within each store. When a job 100 is created, it is also assigned to at least one class 720. By assigning each job 100 to a class 720, teams 700 that work with that class 720 can be easily viewed and selected.

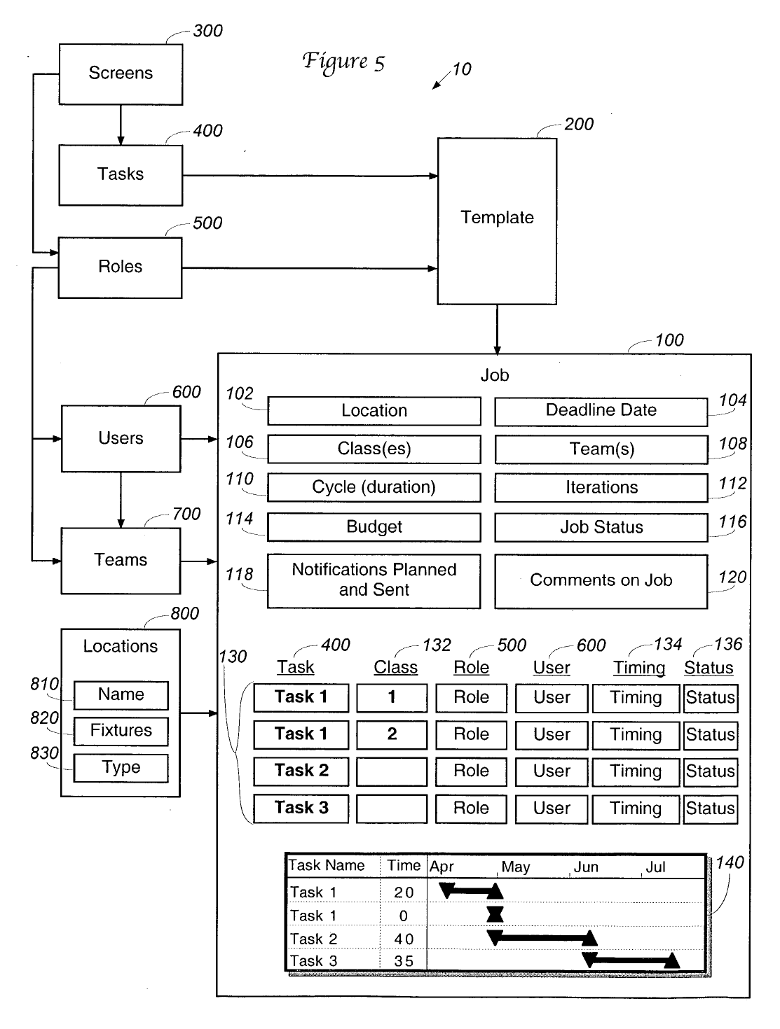

All of the roles 500 that form part of a team 700, as determined by field 520, are part of the set of roles 730 that define a team 700. This set of roles 730 has a generally corresponding set of users 740, such that for most or all of the roles 500 in set 730, there is a user 600 in set 740 that is assigned to that role 500. In effect, a team 700 can be considered a group of users 740 that perform a group of roles 730. This allows an entire team 700 to be assigned to a job 100, which then automatically assigns the users 600 in set 740 to the roles 500 that are expected to complete the job 100. This is explained in more detail in connection with FIG. 5.

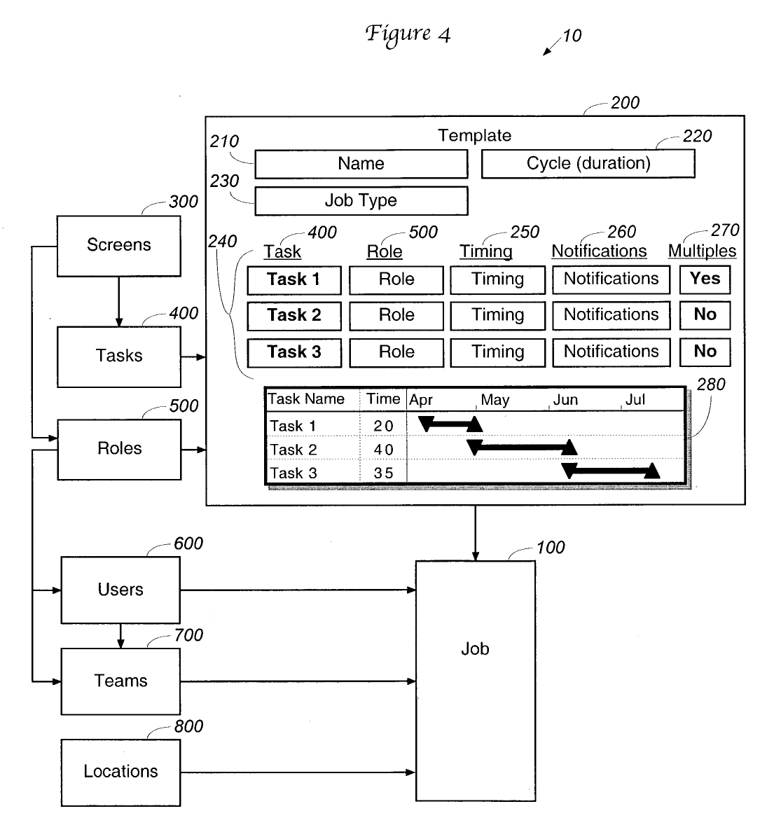

FIG. 4 shows the details of a template 200. Each template 200 is assigned a template name 210 to identify the template 200 in system 10. The cycle or duration 220 field defines how long a promotion planned using this template 200 will last. The template 200 is also assigned a job type 230, which is a descriptive phrase explaining when and how this particular template 200 should be used to define a job 100. For example, one template may be used to plan checkout lane promotional spaces, where each promotion has a duration of two months. Another template could also be used for checkout lane promotions, but this second template might only have a duration of one month, or may utilize a different grouping of tasks. A third template would be used for direct mail advertisements to selected previous customers. By using the job type field 230 to describe the basic nature of the different templates 200, an administrator can more easily distinguish between templates 200 when defining a new job 100.

The template 200 functions to group together a series of predefined tasks 400 in a specific order. This is shown in table 240 in FIG. 4, which is shown containing three tasks 400: Task 1, Task 2, and Task 3. An administrator who is defining the template 200 could choose as many or as few tasks 400 as they desire to be a part of this template 200. As mentioned above, a test could be inserted that would allow only certain tasks 400 to take the first or final position in a template 200 or job 100 definition. In the preferred embodiment, the tasks 400 in table 240 are arranged in the order in which they will be performed, with each task 400 being dependent on the completion of the task 400 listed before it in table 240. It would be a simple matter to allow an administrator to change such dependencies so as to allow some tasks to occur in parallel and to make other tasks 400 dependent on the successful completion of more than one other task 400. This more advanced implementation of task dependencies is common in prior art workflow management systems, and therefore is not presented in more detail here.

Table 240 assigns each one of these tasks 400 to a particular role 500 that will be responsible for completing that task 400. Assignments to actual users 600 do not take place until the template 200 is used to create an actual job 100.

Table 240 allows an administrator to determine when the tasks 400 should be initiated and how long users 600 should be given to complete each task 400. The preferred embodiment bases these timing considerations on the date in which the promotions will be implemented. For instance, one task 400 might be initiated eight weeks before this date, and be expected to take three days to complete. Regardless of how this type of timing information is defined, it is associated with a particular task 400 in table 240 and stored in timing field 250.

Table 240 also allows an administrator to determine how users 600 should be notified that a task 400 is waiting for them, and how reminder notifications should be sent. For instance, an administrator might want to send an e-mail message to a user 600 whenever a new task 400 is waiting for them. Another e-mail could be sent if the deadline for task 400 is due within the next day. Finally, if a task 400 is overdue, the system 10 could notify both the user 600 and a job supervisor that the task 400 is now overdue and further delay could jeopardize the overall job 100. These types of settings would be made in the notification field 260 for each task 400 listed in table 240. Of course, to implement this type of notification system, the definition of a user 600 must include the necessary contact information for that user 600.

Finally, table 240 includes a multiples field 270, which specifies whether a separate task 400 is created for each class associated with a job 100 based upon this template 200. If the multiples field 270 is assigned a value of “yes,” such as with Task 1, that task 400 will be duplicated for each class that is assigned to the job 100. Thus, if a job 100 is assigned to two classes and is created using template 200, then there will be two instances of Task 1 and one instance of Task 2 and Task 3 within that job 100.

Template 200 also includes a graphically display 280, showing each of these tasks 400 in the template 200. The bar chart on the right side of display 280 shows the timing information 250 in a standard, timeline format.

Once a template 200 is defined, it can be used to create a job 100 that defines the actual tasks 400 necessary to complete a promotions plan. The details of a job 100 in the present invention system 10 are shown in FIG. 5. The first field in the description of a job 100 is the location field 102. This location field 102 identifies a particular promotion's location 800 for which a plan is being created. A location 800 could be a physical promotional space location within a store, a market area for print, radio, or television advertisements, or even a location with an e-commerce web site. Generally, a retailer will store information about promotional locations 800 in a separate database. The information that might be stored in such a database will vary according to the type of location being represented. For instance, if the location 800 were a physical promotional space location, the database would include the name of the location 810 as used by the system 10, the type of fixtures 820 available, and the location's type 830. The possible types of fixtures 820 include shelves, racks, and floor displays, which can affect the type of displays that can occur at a promotional space location. The location's type 830 would indicate whether the promotional location 800 is an end cap, a freestanding floor display, a checkout location, or some other category of location.

Once a location 800 is selected in the location field 102, a deadline or implementation date 104 is determined. A job 100 in the present invention is defined as a unique promotions plan for a particular location 800 at a particular implementation date 104. Thus, these two fields 102, 104 will uniquely identify a job 100.

As explained above, each job 100 is assigned to at least one class, which is accomplished in the class field 106. The classes will be selected from the same classes used to define the teams 700. Once the class is selected in field 106, the team 700 that will implement this job 100 will be chosen in field 108. In the preferred embodiment, the administrator setting up the job 100 will be able to choose a team 700 from a list of those teams 700 that have been assigned to the same class as the job 100. If multiple classes have been assigned in field 106, multiple teams 700 should be selected in field 108, with one team 700 for each class in field 106. When multiple entries exist in class field 106 or team field 108, one entry in the fields 106, 108 is selected as the primary entry.

The duration 110 for the job 100 defines how long the planned promotions will remain in the store once implemented. When a job 100 is created, duration field 110 will be filled in based on the value of field 220 in the template 200 used to create the job 100. However, the actual duration of the promotion can be altered as necessary to meet the requirements of the particular job 100. One way of altering this time frame is with the iterations field 112. When this field 112 is used, the duration field 110 indicates the length of a standard cycle for a particular location 800, and the iterations field 112 indicates the number of cycles 110. For example, a retail store may have a general policy that end cap locations should be changed every two weeks. In some circumstances, it may be appropriate to keep the location unchanged for several iterations of this cycle, such as for four, six, or eight weeks. In these circumstances, the iterations field 112 can be used to define the number of cycles that the space will remain unchanged, with the duration field 110 defining the length of each cycle. In fact, the system 10 could actually treat a multiple-iteration plan as a number of separate, duplicate plans that will be implemented back-to-back. Alternatively, the iterations field 112 could simply be removed and the duration field 110 could be directly alterable.

When a job 100 is created, a budget 114 can be assigned to this job 100. This budget FIG. 114 can be used as an implementation budget, such that all costs associated with implementing this promotions plan should be less than the budget amount. In this case, the budget FIG. 114 would have no relationship to the cost of goods sold at the location 800, and hence would relate only to promotional costs. Alternatively, budget FIG. 114 could reflect the costs of goods, which will limit the total value of goods that will be stocked for this promotion.

The job status field 116 indicates the status of the current job 100. This field 116 will be updated automatically by the system 10, thereby allowing an administrator to easily monitor the jobs 100 pending in system 10. The detail of information presented in the status field 116 can vary depending upon the needs and desires of the administrators.

The notifications planned and sent field 118 is also used by administrators to follow the progress of the job 100. When the job 100 is created, this notifications field 118 will contain all of the notifications that might be sent out for this job 100, based upon the notifications field 260 of the template 200 used to create this job 100. As tasks 400 are preformed, notices will be sent to the appropriate user 600 in accordance with these planned notifications. Notices that are sent are also tracked in field 118, so that at any moment an administrator can get a sense of when users 600 have been notified of tasks 400 and what notices are about to be sent.

The comments field 120 contains the comments that are made about a particular job 100 during the performance of the job 100 by the users 600. This comments field 120 is one way in which users 600 can communicate with other users 600 about peculiarities encountered for this particular job 100.

The tasks table 130 shows the actual tasks 400 that will be performed for this job 100. This table 130 is similar to the table 240 used to define a template 200, but the two tables 130, 240 differ in several respects. First, the notifications field 260 from the template's table 240 has been used to create the notifications planned and sent field 118, and hence is removed from the task's table 130. This is mostly a semantic difference, in that it would still be possible to relate each of the planned notifications to a particular task 400 in a job 100 if one so desired.

Another distinction is that the job's tasks table 130 removes the multiples field 270 in template's table 240. The content of this field 270 is used by the job 100 to create duplicate tasks 400 for multiple classes in the classes field 106. For example, the template 200 shown in FIG. 4 requires that multiple tasks be created for Task 1 whenever multiple classes are assigned to a job 100. The tasks table 130 of FIG. 5 shows that two tasks named Task 1 have been created. FIG. 5 shows class number 1 and 2 in field 132, although the actual value assigned to field 132 will be taken from the content of the classes field 106. No duplicates were created for Task 2 and Task 3, since the multiples field 270 in template 200 did not require that multiples be created for these tasks. These tasks 400 will be associated with the primary class listed in field 106.

Both of the tables 130, 240 include a column for a role 500 to be assigned to each task 400. However, the table 130 in the job 100 definition includes another column for a specific user 600 to be assigned to each task 400. The users 600 are automatically assigned during the creation of a job 100 based upon the team 700 selected in field 108. The role 500 for each task 400 in table 130 is examined, and the user 600 that fulfills that role 500 for the selected team 700 is assigned to that task 400. When multiple teams 700 exist in field 108, then the class field 132 is examined, and the team 700 associated with the class indicated in field 132 is used to assign the user 600.

The final distinction between the two tables 130, 240 is the inclusion of a status field 136 in table 130. This field indicates the current status of each of the tasks 400 when a job 100 is being implemented. Such a status field 136 is not necessary in a template 200, since a template 200 would never be implemented without creating a new job 100.

FIG. 5 also shows a graphical timeline 140 showing the tasks 400 of table 130 in a graphical timeline. This display can be automatically updated as some tasks get completed early, and others are overdue.

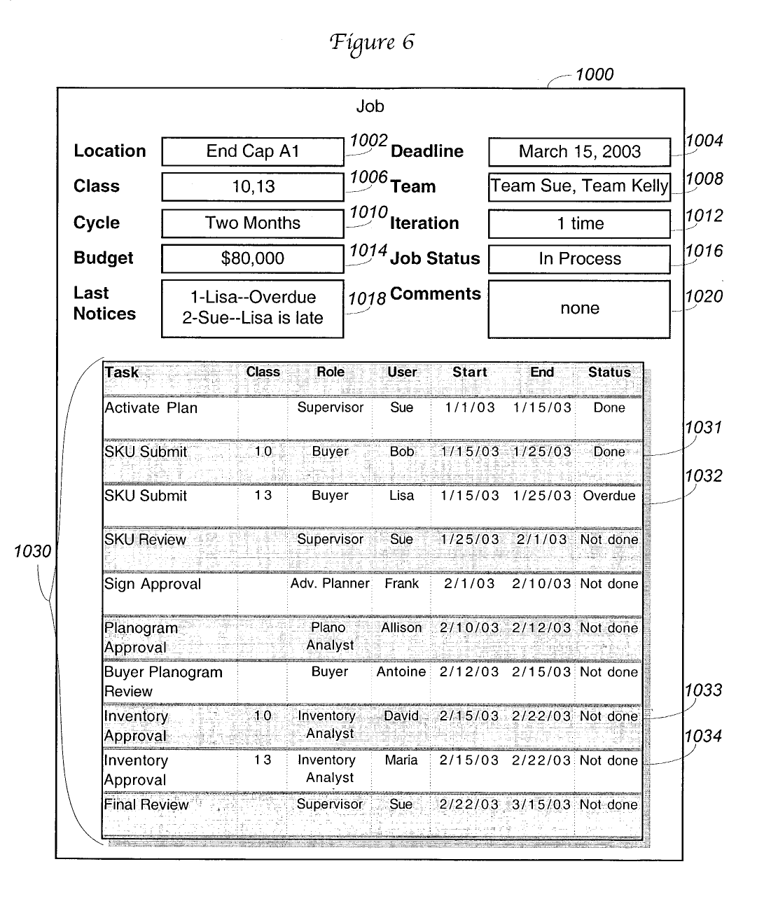

FIG. 6 shows sample data in a job 1000 created using the system 10 of the present invention. Most of the sample data shown in job 1000 is self-explanatory. The job 1000 is for End Cap A1, and is to be implemented on Mar. 15, 2003 (as indicated by fields 1002 and 1004). Two classes have been assigned in field 1006, meaning that two teams must be selected in field 1008. Once implemented, the promotions will remain in the stores until May 15, 2003, as indicated by the cycle length 1010 and the single iteration indicated in field 1012. The job 1000 has a budget of $80,000 (field 1014), and is “in process” right now (field 1016). No comments have been made by any of the users 1020 relating to this job 1000.

FIG. 6 shows that the last notices sent relate to the fact that Lisa (the buyer in Team Kelly) is late in performing the SKU Submit task, as indicated in notices field 1018 and task 1032. Task table 1030 indicates that there are two SKU Submit tasks 1031, 1032, and two Inventory Approval tasks 1033, 1034. This reflects the fact that two classes were indicated in field 1006 and that these tasks 1031-1034 were defined in a template 200 with the multiples field 270 set to “yes.”

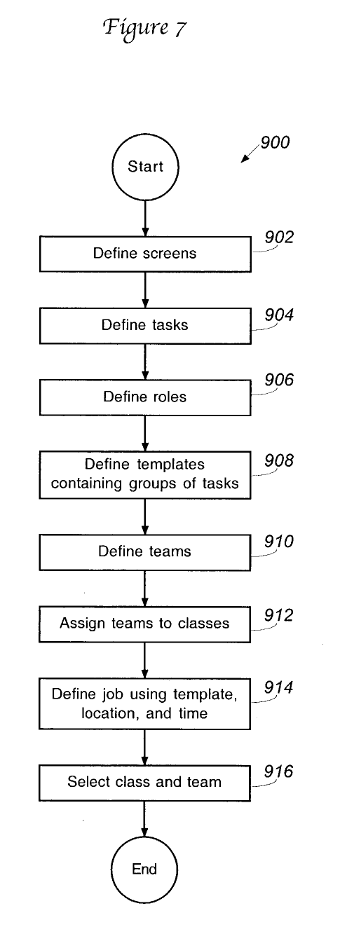

FIG. 7 shows a method 900 for defining a job 100 using the system 10 of the present invention. The first step 902 is to define one or more screens 300 containing user interfaces and programming necessary to perform useful work or to obtain an indication of approval from a user 600. Next, in step 904, the screens 300 are combined into units of works known as tasks 400, which will be performed by the users 600. In step 906, roles 500 are defined to set forth the business positions that can be filled by individuals in a retail store environment. After the screens 300, tasks 400, and roles 500 are defined, step 908 defines a template 200. The template 200 groups together a series of tasks 400 in a particular order that will allow a promotion in a retail environment to be planned. Each of the tasks 240 in the template 200 is assigned to a role 500.

Once the template 200 is defined in step 908, step 910 groups together multiple users 600 into teams 700. Each of the teams 700 can be identified with a particular class that is used by the retail store to logically divide their promotions, which is accomplished in step 912. After the teams 700 are created and assigned to a class, step 914 can be used to define a job 100 that plans a promotion for a location 800 at a particular time. The job 100 is created using a particular template 200, which specifies the tasks 400 that will be performed in the job 100. When a class is selected for the job 100 in step 916, a team 700 of that same class can be used to assigned particular users 600 within that team 700 to the tasks 400 associated with the job 100 being defined.

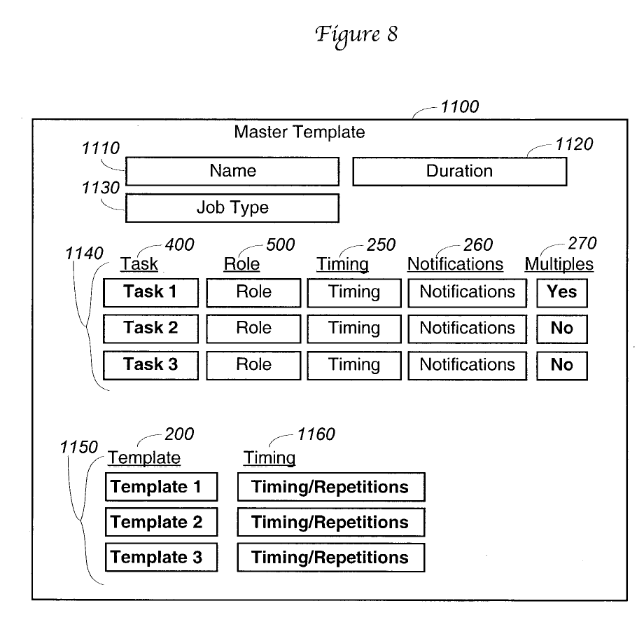

FIG. 8 shows one possible implementation of a unifying master template 1100 to link two or more separate templates 200 together as part of a single promotional event. For example, a master template 1100 can be used to define a promotional event in which in-store promotional space was tied to a print advertisement and a web site promotion. Like other templates 200, a master template 1100 is given a name 1110, duration 1120, and a job type 1130. These values perform the same functions as the identically named values in a normal template 200.

The master template 1100 also has a list 1140 of preliminary tasks 400 that are common to the entire promotional event being planned by the master template 1100. For example, it would be useful to initiate a promotional event through an activate plan task, which requires an employee of sufficient authority to initiate the event. Additionally, the preliminary tasks 1140 might include tasks 400 that select the products beings sold as part of the promotional event (such as the SKU Submit and SKU Review tasks shown in FIG. 6). Like the tasks 400 in the task list 240 of a normal template 200, the preliminary task list 1140 allows tasks 400 to be repeated for multiple classes through use of the multiples field 270.

The master template 1100 also contains list 1150 of sub-templates 200 that together plan the entire promotional event. In the hypothetical promotional event tying an in-store promotional space with print advertising and a web site promotion, one template 200 defines the promotional space planning job, one template 200 defines the print advertising job, and one template 200 defines the web site promotion job. These three separate templates 200 would appear together in the sub-template list 1150 in a master template record 1100. Each template 200 in the sub-template list 1150 can also be associated with a timing/repetition field 1160 that indicates when each template 200 should be initiated in relation to the master template 1100. For instance, in the hypothetical promotional event, a promotional planner may desire to utilize the promotional space for six weeks, to run the web site promotion for only the first two of those weeks, and to distribute the print advertisement during week one and week four. This information could be specified in the timing/repetition field 1160, including the repetition of the print advertisement template 200.

The creation of a master job from this master template 1100 is similar to the creation of a job 100 from a normal template 200, as described above. The name 1110, duration 1120, and a job type 1130 fields are entered when the master job is created. The details concerning the preliminary tasks 1140 would be entered just like the tasks 400 in task list 240 found in a normal job 100. Each of the sub-templates 1150 would then be converted into jobs 100 (“sub-jobs”) like any other template 200, with multiple jobs 100 being created for a single row in the sub-template list 1150 if indicated in the timing/repetition field 1160.

When a master job created from a master template 1100 is implemented, the preliminary tasks 1140 are performed first. When these preliminary tasks 1140 are complete, then the jobs 100 defined by the sub-templates 1150 are initiated, and given access to the data and permissions obtained through the performance of the preliminary tasks 1140. In this way, the preliminary tasks 1140 can perform initial tasks 400 and define data values (such as the product SKU) that are then used by all of the jobs 100 defined by the sub-templates 1150.

Of course, many possible combinations of features and elements are possible within the scope of the present invention. For instance, although various fields were described in each of the major components of the defined system 10, it would be well within the abilities of someone of ordinary skill to alter these components by adding new fields, or by combining together some of the described fields. In addition, it would be possible to combine some of the major components without fundamentally altering the scope of the present invention. For instance, it would be a simple matter to define both users 600 and teams 700 in the same database, thereby creating a single users & teams component. This type of change would not alter the fundamental nature of the present invention. Because many such combinations are present, the scope of the present invention is not to be limited to the above description, but rather is to be limited only by the following claims.

What is claimed is:

1. A system for planning promotions in a retail environment that can be implemented in a workflow management system, the system comprising:
a) a plurality of tasks each having at least one screen, the screen having a user interface and logic necessary to allow a user to complete a unit of work;
b) a plurality of roles,
c) a plurality of templates each having a first ordered set of tasks, with each task in the first ordered set having an assigned role;
d) a team having
i) an assigned class, and
ii) a plurality users, each user having at least one assigned role; and
e) a job associated with one template, the job having
i) an implementation date,
ii) at least one job class,
iii) at least one assigned team having the same assigned class as the job class, and
iv) a second ordered set of tasks derived from the first ordered set of the associated template, each task in the second ordered set being assigned to a user within the assigned team according to the assigned role of the user and the role assigned to the task in the first ordered set.

2. The system of claim 1, further comprising a plurality of promotion locations, with each job having one assigned promotion location.

3. The system of claim 2, wherein each promotion location relates to a promotional space location within a retail store.

4. A system for planning promotions in a retail environment that can be implemented in a workflow management system, the system comprising:
a) a plurality of tasks;
b) a plurality of roles;
c) a plurality of users;
d) at least one team comprising a plurality of users, each user in the team having at least one assigned role;
e) a plurality of templates each having a first ordered set of tasks, with each task in the first ordered set having an assigned role;
f) a job associated with one template, the job having
i) at least one assigned team, and
ii) a second ordered set of tasks derived from the first ordered set of the associated template, each task in the second ordered set being assigned to a user within the assigned team according to the assigned role of the user and the role assigned to the task in the first ordered set.

5. The system of claim 4, further comprising a plurality of classes, wherein each team is assigned to a class; further wherein the job is assigned to the same class as the class assigned to the one assigned team.

6. The system of claim 5, wherein the job is assigned a first class and a second class; and further wherein job has two assigned teams, the first assigned team being assigned to the first class and the second assigned team being assigned to the second class.

7. A system for planning promotions in a retail environment that can be implemented in a computerized workflow management system, the system comprising the following computer defined constructs:
a) a master template associated with a plurality of sub-templates;
b) each sub-templates each having a first ordered set of tasks;
c) a sub-job associated with each sub-template, each sub-job having a second ordered set of tasks derived from the first ordered set of the associated template;
wherein each of the sub-jobs performs a different aspect of a single promotional event.

8. The system of claim 7, wherein the master template is associated with a third ordered set of tasks, and further comprising a master job associated with the master template, the master job having a fourth ordered set of tasks derived from the third ordered set of tasks.

9. The system of claim 8, wherein at least a portion of the fourth ordered set of tasks is performed before the performance of any of the second ordered sets of tasks associated with the sub-jobs.

10. The system of claim 9, wherein data is obtained from a user by performance of the fourth ordered set of tasks, and this data is shared with the second ordered sets of tasks.

11. A method of planning promotions in a retail environment comprising:
a) defining tasks containing a unit of work to be performed by a user;
b) defining roles to which users are assigned;
c) defining templates as a template ordered set of tasks, with each task assigned to a particular role;
d) defining teams, each team having a set of users, each member in the set of users being assigned to a particular role;
e) instantiating a new job based on a template, including the creation of a job ordered set of tasks derived from the template ordered set of tasks,
f) assigning a particular promotion and an implementation date to the new job;
g) selecting a team for the new job; and
h) assigning users within the set of users in the selected team to each task in the job ordered set of tasks according to the assigned role of the user and the role assigned to the corresponding task in the template ordered set.

12. The method of claim 11, wherein multiple teams are selected for the new job.

13. The method of claim 12, wherein the step of defining templates as a template ordered set of tasks further comprises assigning a positive multiples value to at least one multiples task, the multiples value indicating that the job ordered set of tasks derived from the template ordered set of tasks should include one multiples tasks for each team selected for the new job.

14. A method of planning promotions in a retail environment comprising:
a) defining tasks containing a unit of work to be performed by a user;
b) defining roles to which users are assigned;
c) defining templates as a template ordered set of tasks, with each task assigned to a particular role;
d) defining teams assigned to a class, each team having a set of roles and a set of users, each member in the set of users being assigned to a particular role in the set of roles;
e) instantiating a new job based on a template, including the creation of a job ordered set of tasks derived from the template ordered set of tasks,
f) assigning a particular promotions and an implementation date to the new job;
g) selecting a job class for the new job;
h) selecting a team for the new job, the team having the same class as the job class; and
i) assigning users within the set of users in the selected team to each task in the job ordered set of tasks according to the assigned role of the user and the role assigned to the corresponding task in the template ordered set.
